(19) United States
(12) Patent Application Publication
(10) Pub. No.: US 2025/0384245 A1
(43) Pub. Date: Dec. 18, 2025

(54) NEURAL ARCHITECTURE FOR EXPLAINABLE CLASSIFICATION (XCLS) WITH NATURAL LANGUAGE JUSTIFICATION AND EXPLICIT SALIENCY DETECTION

(71) Applicant: Palo Alto Networks, Inc., Santa Clara, CA (US)

(72) Inventors: Brody James Kutt, Santa Clara, CA (US); Sujit Rokka Chhetri, San Jose, CA (US); Nandini Ramanan, Sunnyvale, CA (US); Sheng Yang, San Jose, CA (US); Samarth Keshari, San Jose, CA (US); William Redington Hewlett, II, Mountain View, CA (US)

(21) Appl. No.: 18/744,406

(22) Filed: Jun. 14, 2024

(51) Int. Cl. G06N 3/0455; G06N 3/08

(52) U.S. Cl. CPC G06N 3/0455; G06N 3/08

(57) ABSTRACT

Techniques for a neural architecture for explainable classification (XCLS) with natural language justification and explicit saliency detection are disclosed. In some embodiments, a system/process/computer program product for a neural architecture for XCLS with natural language justification and explicit saliency detection includes generating a classifier (e.g., a neural network that co-trains the discriminator for security classification and the generator for natural language explanation) that is applied to perform the following: (1) force an explicit selection of salient input regions and (2) co-train a discriminator for security classification and a generator for natural language explanation with shared weights; applying the discriminator, the generator (e.g., an LLM decoder), and attention losses to jointly learn to up-weight a salient subset of spatial input regions to ensure alignment; and generating a discriminator verdict using the classifier based on this bottlenecked information, and using the generator to output a natural language explanation of the discriminator verdict.

### BACKGROUND OF THE INVENTION

A firewall generally protects networks from unauthorized access while permitting authorized communications to pass through the firewall. A firewall is typically a device or a set of devices, or software executed on a device, such as a computer, that provides a firewall function for network access. For example, firewalls can be integrated into operating systems of devices (e.g., computers, smart phones, or other types of network communication capable devices). Firewalls can also be integrated into or executed as software on computer servers, gateways, network/routing devices (e.g., network routers), or data appliances (e.g., security appliances or other types of special purpose devices).

Firewalls typically deny or permit network transmission based on a set of rules. These sets of rules are often referred to as policies. For example, a firewall can filter inbound traffic by applying a set of rules or policies. A firewall can also filter outbound traffic by applying a set of rules or policies. Firewalls can also be capable of performing basic routing functions.

### BRIEF DESCRIPTION OF THE DRA WINGS

Various embodiments of the invention are disclosed in the following detailed description and the accompanying drawings.

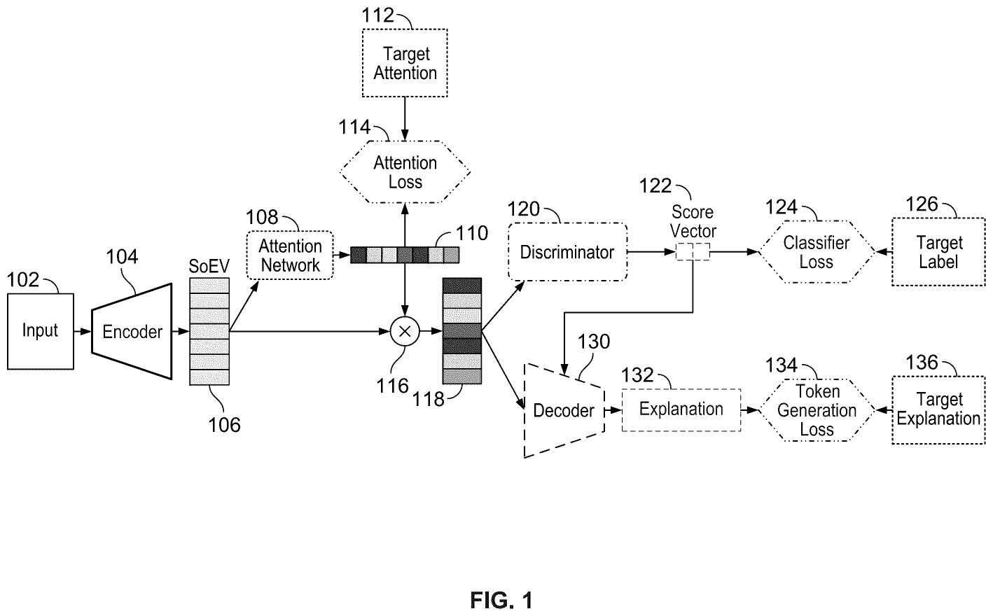

FIG. 1 illustrates a neural architecture for explainable classification (XCLS) with natural language justification and explicit saliency detection in accordance with some embodiments.

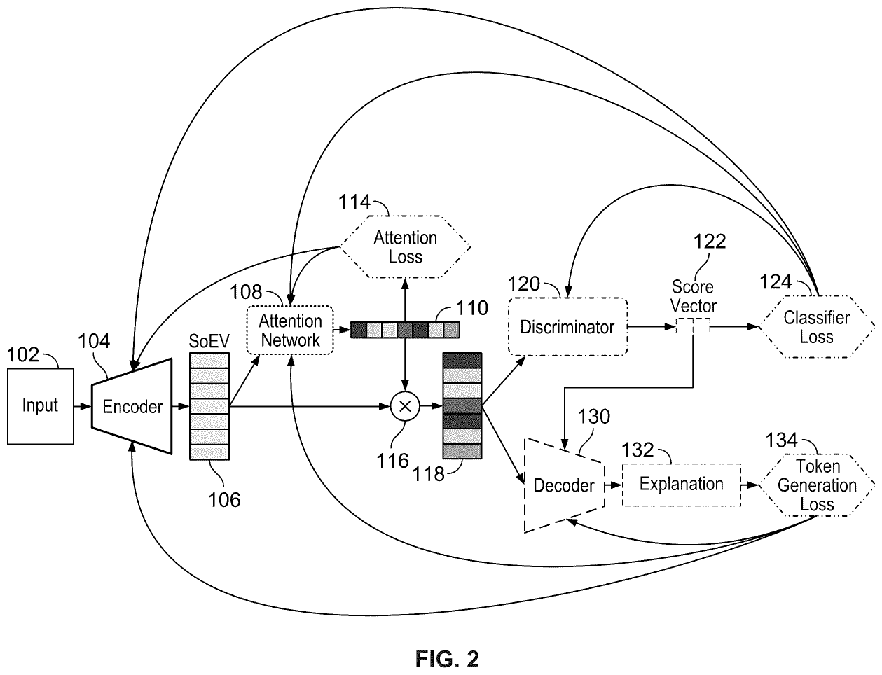

FIG. 2 illustrates the neural architecture for explainable classification (XCLS) with natural language justification and explicit saliency detection with the relationship of the attention loss, classifier loss, and token generation loss during a training of the neural architecture in accordance with some embodiments.

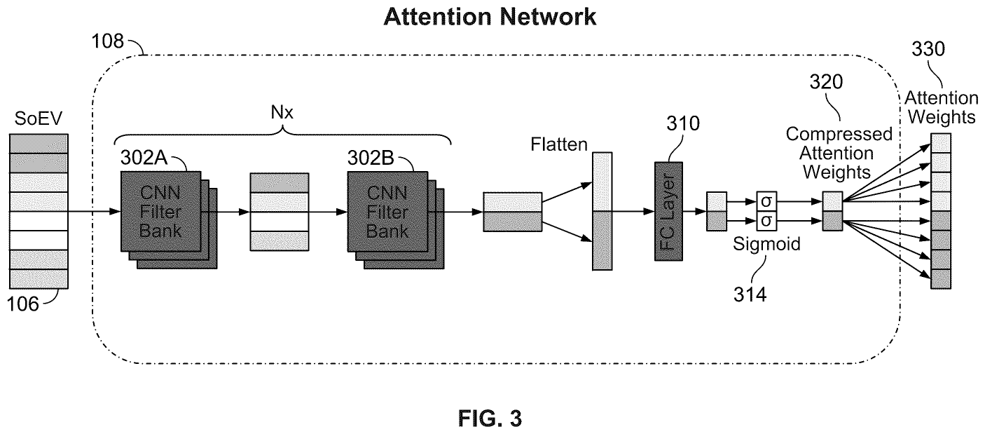

FIG. 3 illustrates components of an attention network in accordance with some embodiments.

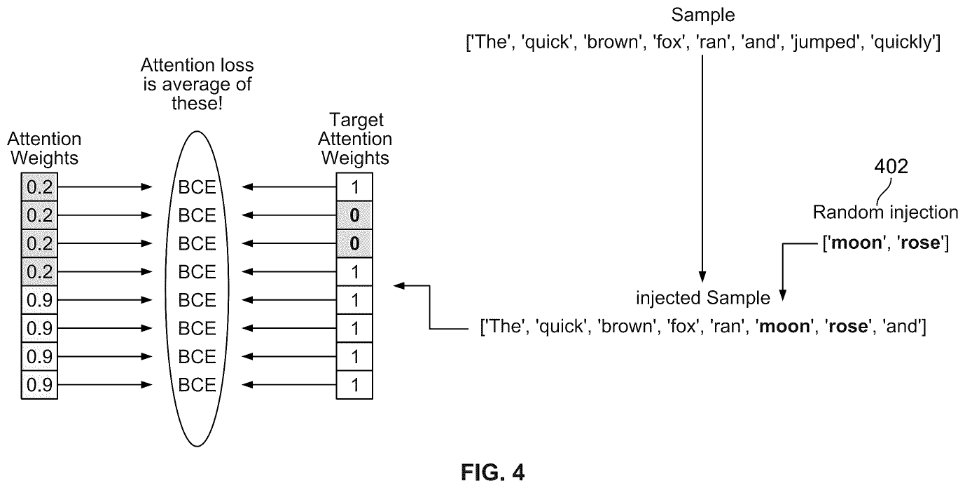

FIG. 4 illustrates an example self-supervised loss function for an attention network in accordance with some embodiments.

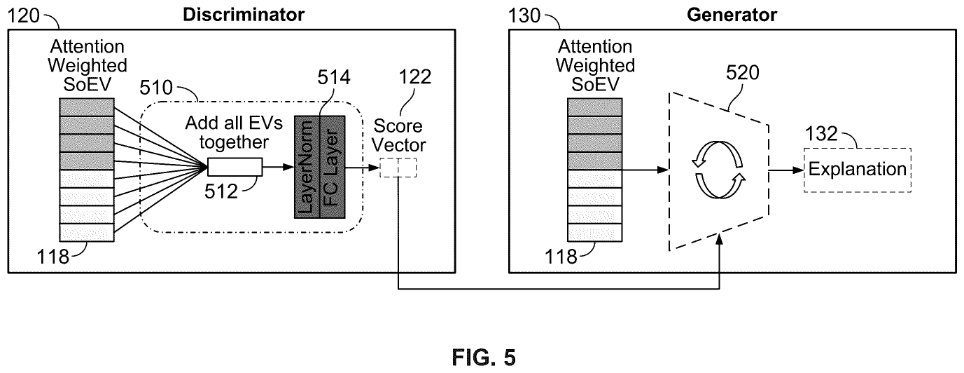

FIG. 5 illustrates components of a discriminator and a generator in accordance with some embodiments.

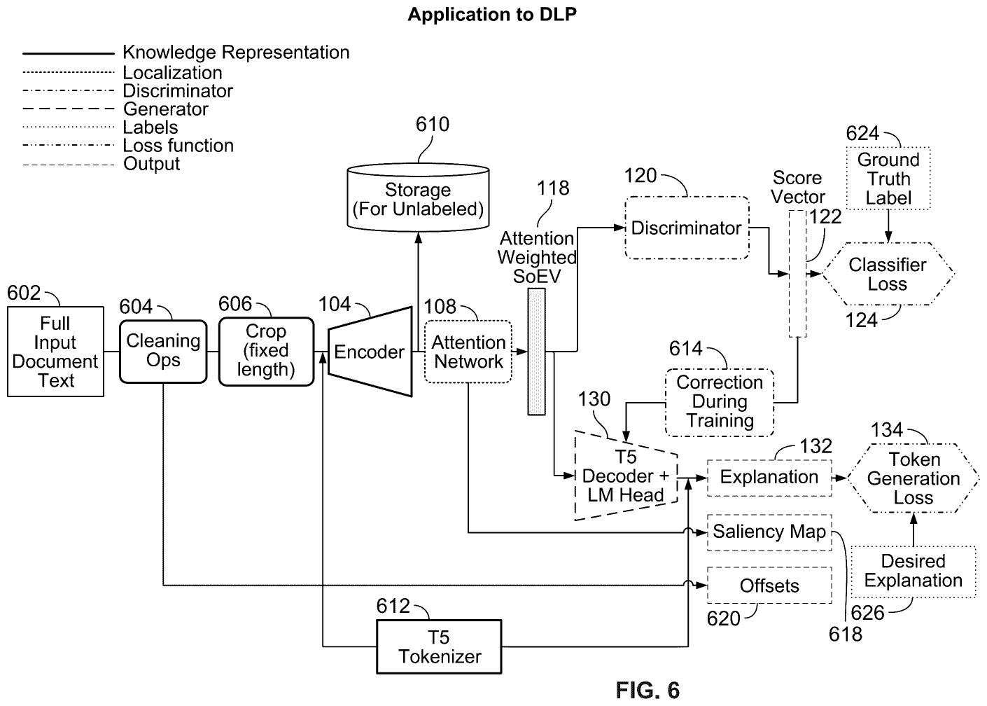

FIG. 6 illustrates a neural architecture for explainable classification (XCLS) with natural language justification and explicit saliency detection for a Data Loss Prevention (DLP) application in accordance with some embodiments.

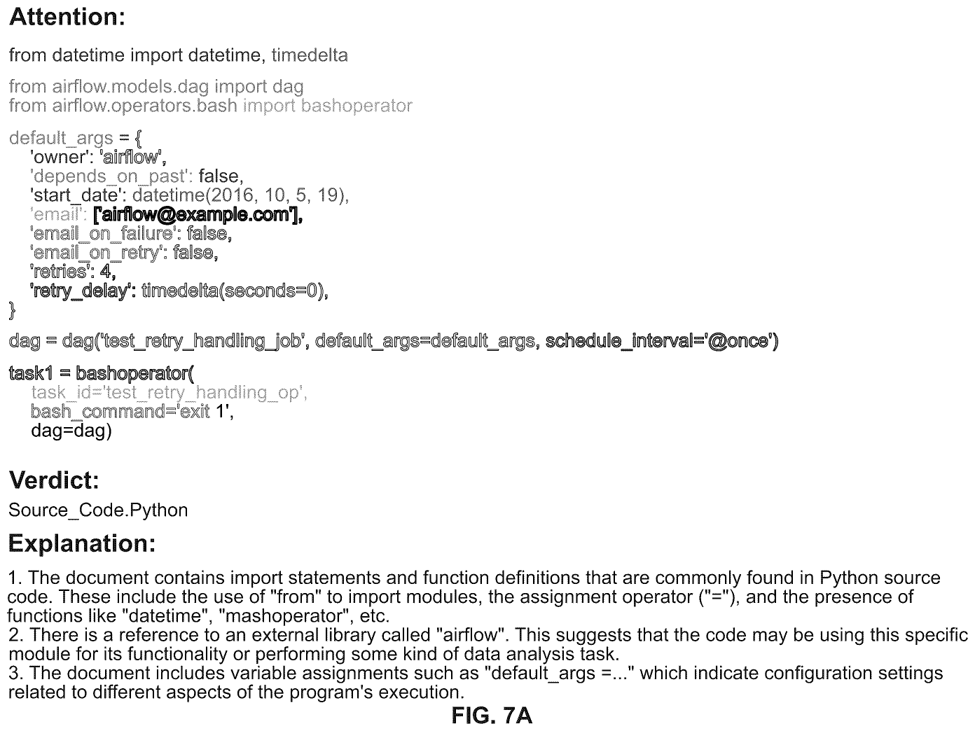

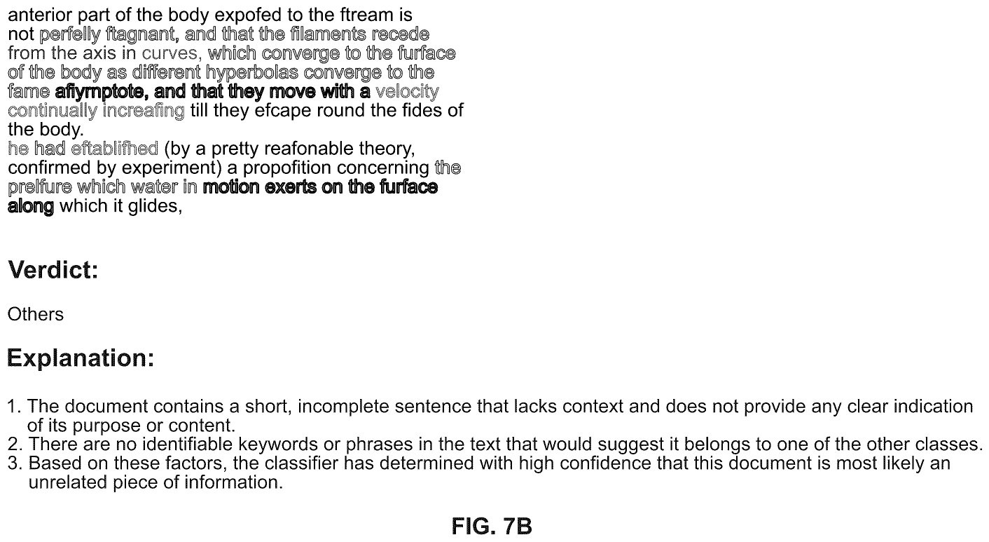

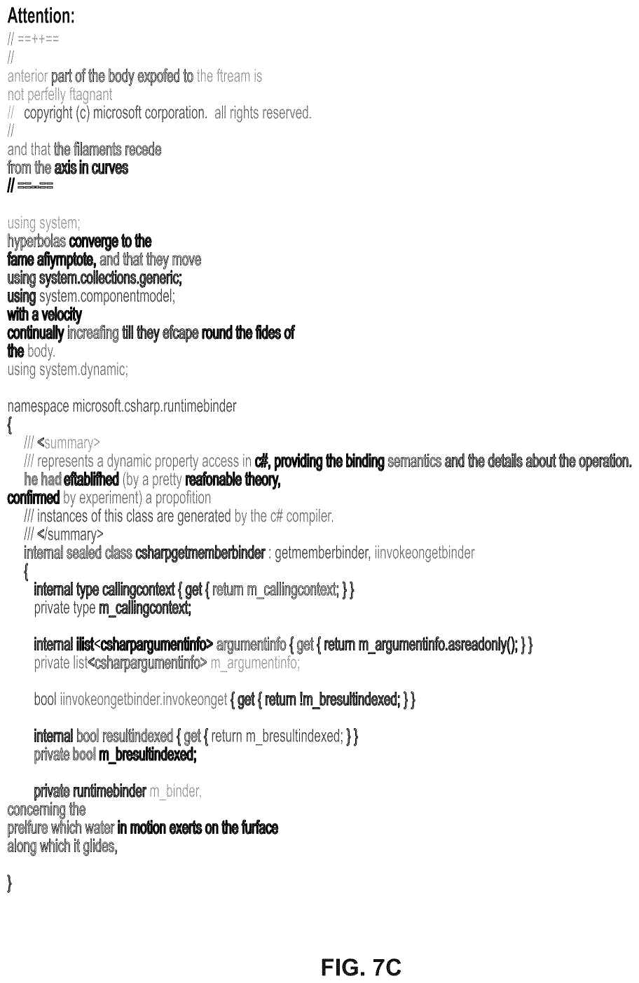

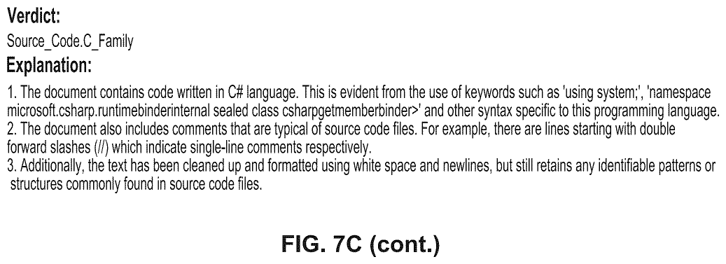

FIGS. 7A-7C illustrate example DLP verdicts, saliency maps, and natural language explanations in accordance with some embodiments.

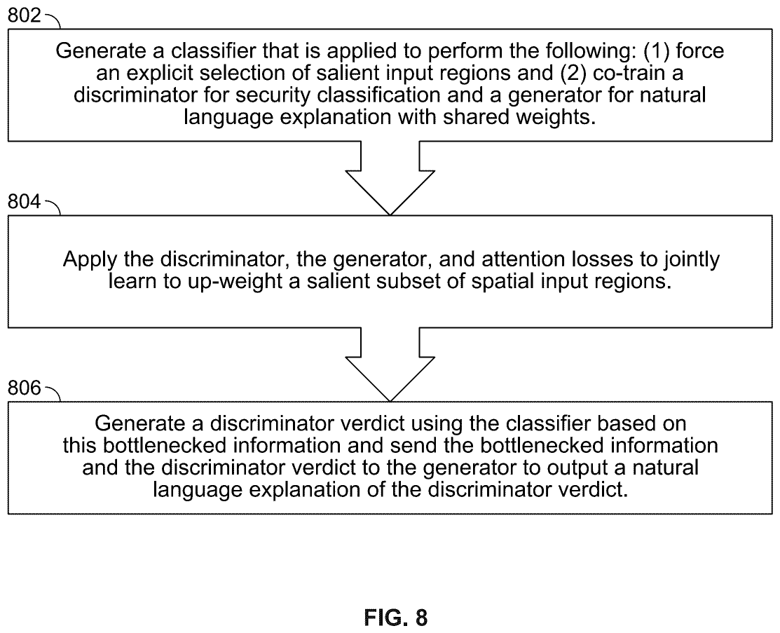

FIG. 8 is a flow diagram for a process for applying a neural architecture for explainable classification (XCLS) with natural language justification and explicit saliency detection in accordance with some embodiments.

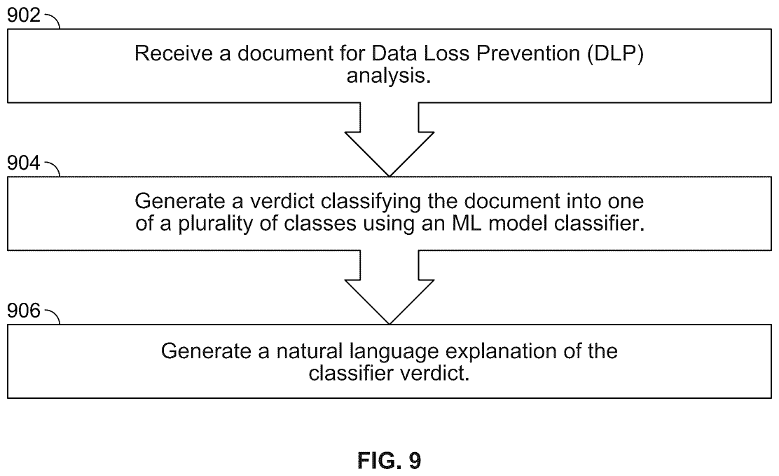

FIG. 9 is another flow diagram for a process for applying a neural architecture for explainable classification (XCLS) with natural language justification and explicit saliency detection in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Machine learning classifiers, especially those based on deep learning, are often a closed/non-transparent box. Usually, the only output you get from the model is a score vector. This makes it very difficult to assess how and why the model has come to that choice. These questions are vitally important for transparency, building trust, and gathering insight into how your model works. Generative AI, particularly LLMs, brings a better capacity to provide explanations of decisions.

However, explanations generated from the verdict of an external discriminator model are inconsistent with the discriminator's true underlying reasoning behavior, in general. Generator models (even fine-tuned ones) lack the classification power and fine-grained control of a purpose-built classifier. As such, using such a non-integrated approach does not provide accurate or consistent insight into the discriminator. The true discriminator behavior and generator explanations can often diverge (e.g., the generator may focus on content that was not actually relevant/salient to the verdict of the discriminator/classifier). Moreover, neither model is enhanced or improved by such a non-integrated approach. Further, absent fine-tuning of the generative model, the generator will typically lack adequate domain-specific information for a given application/domain, such as computer/network security (e.g., security as used herein).

### Overview of Techniques for a Neural Architecture for Explainable Classification (XCLS) with Natural Language Justification and Explicit Saliency Detection

Thus, new and improved techniques for machine learning models, such as for computer security, are needed.

Accordingly, various techniques for a neural architecture for explainable classification (XCLS) with natural language justification and explicit saliency detection are disclosed.

In some embodiments, a system/process/computer program product for a neural architecture for explainable classification (XCLS) with natural language justification and explicit saliency detection includes generating a classifier (e.g., a neural network that co-trains the discriminator for security classification and the generator for natural language explanation with shared weights based on attention-weighted Sequence of Embedding Vectors (SoEV) from an attention network) that is applied to perform the following: (1) force an explicit selection of salient input regions and (2) co-train a discriminator for security classification and a generator for natural language explanation with shared weights (e.g., based on attention-weighted SoEV from an attention network); applying the discriminator, the generator (e.g., a Large-Language Model (LLM) decoder), and attention losses to jointly learn to up-weight a salient subset of spatial input regions (e.g., while down-weighting the rest of an input (e.g., SoEV)) to ensure alignment; and generating a discriminator verdict using the classifier based on this bottlenecked information, and use the generator to output a natural language explanation of the discriminator verdict.

For example, the generator can be implemented using an LLM decoder. To get target explanations for training the decoder, prompt engineering with external generative Artificial Intelligence (AI) services can be used (e.g., and, in some cases, human generated explanations can also be provided for the training). As further described herein, training input can include text, images, video, audio, and/or other forms of content.

In some embodiments, a system/process/computer program product for a neural architecture for XCLS with natural language justification and explicit saliency detection further includes generating a saliency map to facilitate further explainability of a classifier verdict.

In some embodiments, a system/process/computer program product for a neural architecture for XCLS with natural language justification and explicit saliency detection further includes embedding saliency detection into a forward pass of a neural architecture, producing the saliency detection automatically with every classifier verdict, wherein the performances of the discriminator and the generator are enhanced by each other's presence during training.

For example, instead of utilizing expensive offline procedures with external components, the saliency detection can be embedded into a forward pass of a neural architecture, producing the saliency detection automatically with every classifier verdict, wherein the performance of the discriminator and the generator are enhanced by each other's presence during training.

In an example implementation, the disclosed techniques can be applied to provide an integrated and streamlined classification, saliency, and verbal explanation in a single forward pass. Specifically, the disclosed XCLS architecture provides a new neural network topology that performs the following: (1) forces the explicit selection of salient input regions; and (2) co-trains a discriminator and generator with shared weights. As such, the disclosed XCLS architecture combines the robust power of a dedicated classifier with the flexible interpretability of a language generator. To ensure alignment, the two components are implemented to jointly decide upon a minimal set of regions of saliency while down-weighting the rest of the input. The classifier provides a verdict based on this bottlenecked information while the generator then provides a natural language explanation of the verdict.

For example, the disclosed machine learning model architecture (e.g., a neural network architecture, also referred to herein as a neural architecture) is general enough to be applied to any data type that is focused on producing a natural language explanation of a classifier's verdict (e.g., providing a natural language explanation for each classification verdict thereby providing an explainable ML model verdict that is understandable to a human that is not necessarily a domain expert, such as not a security domain expert for an explainable security ML/classification model, such as for Data Loss Prevention (DLP) or other security solutions). Saliency maps provide additional explainability. As such, instead of expensive offline procedures with external components, the disclosed techniques embed saliency detection into the forward pass of the disclosed machine learning model architecture itself, producing it automatically with every classifier verdict.

Specifically, the disclosed machine learning model architecture is implemented by jointly learning a localization procedure with the discriminator's loss, the generator, and attention losses in a single architecture (e.g., localization facilitates the discriminator and the generator both being able to determine content, such as content of a given document(s) for a DLP task, which is not relevant and doing so in a consistent manner, and without the need for human-authored region labels), such as will be further described below. In an example implementation, the disclosed machine learning model architecture provides the following in a single architecture: (1) a classification score vector; (2) a saliency map over the input; and (3) a natural language (NL) explanation of the verdict. Moreover, disclosed machine learning model architecture does not compromise on classification power compared to a dedicated classifier. As such, disclosed machine learning model architecture facilitates a synergistic combination of the intuitive, flexible abilities of a generative model with the precise, reliable abilities of a discriminative model (e.g., providing functionality together that neither could provide alone).

As an example use case, the disclosed new neural architecture for XCLS with natural language justification can be efficiently and effectively applied to provide a data loss prevention (DLP) solution (e.g., in which an output of the encoder of DLP documents, which can be normalized when provided as input during a training phase, is provided to an attention network). Specifically, the DLP classification can be provided along with a natural language explanation of the classification result. More specifically, the DLP automated obfuscation robustness is implemented using attention to extract salient information in DLP documents (e.g., extracting a relevant signal(s) from a noisy document). The training can be performed using multi-task learning with loss functions from both the attention network, the classifier, and the generator (e.g., a decoder LLM). The DLP solution can be implemented using the disclosed techniques to enforce a 0.01% false positive rate (FPR) and a classifier accuracy of 98.90% based on our experiments (e.g., which is significantly better than existing generative models, such as the commercially available ChatGPT generative model available from OpenAI headquartered in San Francisco, CA, that result in much higher FPRs based on our experiments, such as a 1% FPR versus our desired 0.01% FPR), such as will be further described below.

As additional example use cases, the disclosed techniques for a neural architecture for XCLS with a natural language justification and explicit saliency detection can be similarly applied to various other security solutions as would be apparent to one of ordinary skill in the art in view of the disclosed embodiments.

As such, ML model explainability for computer security (e.g., and/or other applications) facilitates the following: (1) transparency of the ML model; (2) bias detection; (3) building trust; (4) debugging; (5) generalization; and (6) decision making. These and other benefits of the disclosed new neural architecture for XCLS with natural language justification will be further described below.

As further discussed below, through an ablation study, we show the performance of the discriminator and generator are enhanced by each other's presence during training.

### Example System Embodiments for Neural Architecture for Explainable Classification (XCLS) with Natural Language Justification and Explicit Saliency Detection

FIG. 1 illustrates a neural architecture for explainable classification (XCLS) with natural language justification and explicit saliency detection in accordance with some embodiments. In this example implementation, an attention network 108, a discriminator 120 (e.g., also referred to herein generally as a classifier), and a generator 130 (e.g., decoder Large-Language Model (LLM)) are jointly learning the following: (1) knowledge representation (as provided by encoder 104); and (2) localization (as provided by attention network 108) (e.g., and each of these components are thereby regularizing each other using the disclosed joint loss learning for the discriminator and the generator as further described below with respect to FIG. 1).

Referring to FIG. 1, an input 102 is provided. The input can include various types of content, including, for example, text (e.g., natural language, programming code, etc.), images, video, audio, combinations thereof, and/or other types of content.

The input is provided to an encoder 104. Assuming, for example, that the input is text, then a tokenizer (e.g., illustrated as a static, unlearned initial operation within the encoder) extracts the sub words to provide a tokenization of the text input and the learnable operations within the encoder then transforms that into a sequence of embedding vectors that represents an abstraction of information contained within the text, such as shown at 106. More generally, the encoder determines spatial regions of the input, transforms each of the spatial regions into an embedding vector, and then that forms a sequence of embedding vectors (106) (e.g., and the ordering is presumably related to the spatial ordering of the input; for example, if the input is an image, then this would be a three-dimensional tensor as we have the x and y position of each vector as it corresponds to the XY position, the XY pixel or region of space on the image and then the extra dimension is this embedding dimension that stores abstract knowledge in this new embedding space). In an example implementation of the encoder, any pre-trained or new tokenizer and encoder that transforms an input into a sequence of embedding vectors can be utilized, in which each embedding vector generally corresponds to a region of input (e.g., a (sub) word, a sentence, a box in an image, a time step, etc.).

The sequence of embedding vectors (106) is sent to an attention network 108 (e.g., a neural network). Generally, the attention network produces a sequence of floating point values each between 0 and 1, and those values determine the salience of the region that it corresponds to that is provided as output as shown at 110, which is referred to herein as the global attention vector. For example, referring to output 110, the darker can represent values being closer to 0. Specifically, the first region, shown as a first block of output 110, is relatively dark, so that effectively translates to this region corresponding to an unimportant region of the input (e.g., less salient portion of the input) as processed by the attention network in this example. In contrast, the third region/block of 110 is relatively light, so that region generally corresponds to a highly salient region of the input as processed by the attention network in this example). In this example implementation, the attention network is, in part, trained on the first loss of this architecture, which is referred to as the attention loss, as will be further discussed below.

Referring to 116, multiplying each of the values of the global attention vector (110) across the rows is performed as shown. As such, a less salient region (e.g., corresponding to a matching darker block of the global attention vector) is effectively down weighted, whereas a salient region (e.g., corresponding to a matching lighter block of the global attention vector) is effectively up weighted, which generates weighted versions of the sequence of embedding vectors as shown at 118 (e.g., providing a weighted localization of the input).

As shown at 120 and 130, the weighted localization of the input (118) is sent to a discriminator model 120 (e.g., an ML model for classification, also referred to herein generally as a classifier) to generate a score vector 122 as further described below, and is also sent to a decoder 130 (e.g., an LLM decoder) to generate an explanation 132 (e.g., automatically generate a language explanation auto regressively) as will as be further described below. As also shown, the score vector (122) is also sent to the decoder (130) (e.g., as the decoder utilizes the score vector as input to automatically generate a natural language explanation that corresponds to that classification result based on the score vector).

As such, at this stage of processing in the disclosed architecture, there is the score vector (122) and a natural language explanation (132) as well as two additional losses: (1) the classification loss; and (2) the generator loss. As such, there are a total of three losses in the disclosed architecture, as there also is an attention loss as shown at 114, which receives target attention input as shown at 112, and which will be used in order to train the architecture as will be further described below.

FIG. 2 illustrates the neural architecture for explainable classification (XCLS) with natural language justification and explicit saliency detection with the relationship of the attention loss, classifier loss, and token generation loss during a training of the neural architecture in accordance with some embodiments.

Referring to FIG. 2, in this example implementation, the attention loss (114) is serving as a source of supervision for the attention network and the encoder. A classifier loss 124, which receives target label input as shown at 126 as shown in FIG. 1, is serving as a source of supervision for the discriminator, attention network, and encoder (e.g., ensuring class relevance of information stored in the attention-weighted SoEVs 118). A token generation loss 134, which receives target explanation input as shown at 136 as shown in FIG. 1, is serving as a source of supervision and loss signal for the decoder, attention network, and encoder (e.g., the token generation loss can be viewed as facilitating intuitive human interpretable knowledge in the information stored in 118). As such, the encoder (104) and attention network (108), for example, are influenced by all three of these loss functions (114, 124, and 134). In contrast, the discriminator (120), for example, is only influenced by the classifier loss (124) (e.g., which ensures that the disclosed architecture can still provide a robust classifier result with desired FP rates, etc., such as similarly described above). Finally, the decoder (130) is only influenced by the token generation loss (134). In contrast, if we were just minimizing a classifier loss, the trained network would not need to learn to store human interpretable information needed for producing a human interpretable explanation, because such would effectively just be minimizing a classification loss that could potentially over fit to spurious correlations within the input data that are not human interpretable but effectively minimize the classification loss.

In terms of the benefits of explicit localization provided by the disclosed architecture, it serves as an information bottleneck, which forces the classifier (120) and the explainer (130) to effectively agree upon a minimal subset of information. In other words, such facilitates alignment by forcing the discriminator's behavior and the generator's behavior to align to the actual function that is implemented in the discriminator (e.g., by bottlenecking the information such that the discriminator and the generator only have access to a common minimal subset of information that is relevant to the classification result as facilitated by the attention network focusing attention on the relevant portions of the input, which, for example, significantly reduces/eliminates the risk of the decoder providing an explanation based on information that is not relevant to the classification result or to hallucinate, as a result of the saliency map as described herein). As such, the discriminator and the decoder are each abiding by the same restrictions facilitated by the attention network as provided by the weighted sequence of embedding vectors of the input (118). Thus, this neural architecture facilitates additional explainability in the localization itself.

Moreover, the classifier (120) and the explainer (130) can effectively work together to identify the salient regions of the input. Specifically, the classifier ensures class relevance in the network hidden state (e.g., to minimize the cross-entropy loss with the target class) and the explainer ensures intuitive and explainable information is contained in the hidden state (e.g., to minimize the token-generation loss of the human interpretable explanation).

FIG. 3 illustrates components of an attention network in accordance with some embodiments. Specifically, FIG. 3 illustrates the components of the above-described attention network that is included in the above-described neural architecture for explainable classification (XCLS) with natural language justification and explicit saliency detection.

Referring to FIG. 3, the attention network (108) is effectively a feature aggregation mechanism. Specifically, it is implemented using a series of convolutional layers as shown at 302A and 302B in which each filter bank can reduce the height and width of its state while maintaining the respective spatial equivalence relationship to the respective input as shown in FIG. 3 (e.g., of a Convolutional Neural Network (CNN)) that slowly aggregates information and compresses it (e.g., and such can be repeated to obtain a representation of the input that is desirable in terms of the amount of desired compression for, for example, memory and compute usage as well as to facilitate providing sufficient context for determining attention as similarly discussed above for identifying the salient regions of the input), such as shown at 310, such that each attention value corresponds to a region of input as similarly described above, resulting in compressed attention weights at 320 (e.g., after applying a Sigmoid function 314 to push these values between 0 and 1 as shown in FIG. 3) that are used to generate the output attention weights as shown at 330. This generation of the attention weights (330) can be provided using the compressed attention weights and then by decompressing them back to the original size of the input, which can be repeated along an axis (e.g., the first axis). For example, assume that this is a 4× compression, in which every four elements is reduced to a single attention value. Then to decompress it, we just repeat by four times for each of these to generate our attention vector, where we have two distinct attention values as shown at 330 in FIG. 3.

It is noted that this implementation of the attention network produces attention values over regions, such as spatial regions of the input, sentence by sentence for text input, and as such, the attention values are generally more human interpretable and useful than, for example, providing such on a sub word by sub word or a character-by-character basis for such text input.

FIG. 4 illustrates an example self-supervised loss function for an attention network in accordance with some embodiments. Specifically, rather than training using labeled data, in which every sub-token would require sub-labels to indicate whether or not attention should be paid to the sub-token or not (e.g., which in itself is challenging given that such is often context dependent, that is, task and data dependent), a loss function is provided that does not require such fine-grained region labels to provide the disclosed attention network as described above with respect to FIGS. 1-3.

Referring to FIG. 4, a self-supervised attention loss function is provided. Specifically, random noise is injected into training samples, such as shown at 402, in which at the text level of the sentence of this sample, two random words were injected (i.e., ‘moon’, ‘rose’). In this example, this noise/new content is injected into the sample as shown and then we are moving all of the pre-existing content around that injected content. We can then utilize the positions of the injected words to assign 0 in the target attention weight for that injected noise/new content. The pre-existing content is by default assigned a value of 1 in the target attention weight.

More specifically, attention loss is the average of binary sigmoid cross-entropy losses with the target attention vector crafted by injecting samples dynamically during training with non-salient content right after tokenization. This provides a form of self-supervised learning. We also feed non-injected samples with content that is in which: (1) all salient content is assigned a default attention weight of 1 (e.g., target is 1 vector); and (2) all non-salient content is assigned a default attention weight of 1 (e.g., target is 0 vector) (e.g., and in which padding values get target attention of 0 always), such as shown in FIG. 4.

As such, this provides a self-supervised ML model training technique that effectively trains the attention model to differentiate between what is a real/true signal from noise in the signal.

In addition, we can train clean samples, for example, that is, samples without any random noise injection(s) to verify that the attention loss is attending to the regions of the input that are most important to the classification (e.g., is also facilitated, at least in part, because the attention loss is also post supervised by the attention and by the discriminator's loss in the generator's loss, such as similarly described above with respect to FIGS. 1-3). Moreover, training using non-injected content also ensures that the attention model does not over fit (e.g., in which it may be trained to only act properly on injected content absent training also on non-injected content). For example, training using clean, non-injected content can be performed by using content that is entirely salient or entirely non-salient, such as in a Data Loss Prevention (DLP) application (e.g., the document is either completely relevant for DLP or completely irrelevant for DLP), such as will be further described below.

In this example implementation, an attention gradient is also generated as output from the attention network (e.g., as compared to the global attention weights 330). Specifically, a series of binary cross entropy calculations are performed such that each unique position has an associated binary cross entropy calculation with its target attention weight at that position.

FIG. 5 illustrates components of a discriminator and a generator in accordance with some embodiments. Specifically, example implementations of the discriminator (120) and the generator (130) are further described below with respect to FIG. 5.

Referring to FIG. 5, the discriminator (120) receives attention weighted SoEV 118 as input. The discriminator head then multiplies all of the embedding vectors (EVs) together to enforce the impact of the attention weights. Otherwise, the fully connected (FC) layer, such as shown at 514, could learn to just reverse the attention values. As shown at 510, the discriminator head includes a fully connected layer. As shown at 512, as a first operation, the attention weighted SoEVs are summed together (e.g., to enforce the above-described localization in which all of this information is thereby reduced to a single vector, and that single vector effectively represents the information that is present, that is, that survives the summation operation). The single, final sum vector result at 512 is then sent to a single fully connected layer (e.g., of the CNN implementation of the classifier) to generate the score vector (122) as similarly described above with respect to FIGS. 1 and 2 (e.g., and as also similarly described above, the score vector is also provided through a linear projection to the generator (130), and in an example implementation, to project it to the same dimensionality as the embedding vectors, the projected score vector can be concatenated onto the attention weighted SOEV such that it effectively serves as a prefix to the sequence of embedding vectors in which it is just attached at the beginning and it can then all be sent as input to the generator (130)).

Referring now to the generator (130) as shown in FIG. 5, in this example implementation, the generator is a transformer decoder as shown at 520 (e.g., which can be provided using a commercially available or an open source transformer decoder, such as FLAN-T5 that is a publicly available open source encoder decoder large-language model (LLM) that is pre-trained on generic natural language and is available at https://huggingface.co/docs/transformers/en/model_doc/flan-t5, which provides a relatively small LLM that utilizes about 80 million parameters, which is desirable for security applications, such as DLP, that can be used to process, for example, millions of files for DLP analysis each single day for DLP classification and explanation). Specifically, the full attention-weighted SoEV 118 is passed to the generator (130) as shown in FIG. 5 (e.g., during training, the corrected score vector, that is, the ground truth score vector, can be provided to the generator) to generate the explanation (132), as similarly described above with respect to FIGS. 1 and 2.

FIG. 6 illustrates a neural architecture for explainable classification (XCLS) with natural language justification and explicit saliency detection for a Data Loss Prevention (DLP) application in accordance with some embodiments. In this DLP application, training was performed using approximately two million samples with greater than sixty different sensitive classes. Examples of these sensitive classes can include source code classes, financial classes, legal health care classes, etc. We also have a non-sensitive class (e.g., which is the definition of non-salient for the disclosed neural architecture for XCLS with natural language justification and explicit saliency detection).

Referring to FIG. 6, at 602, full input document text is provided. At 604, pre-processing of the document text is performed to normalize the text input (e.g., cleaning operations (ops) that can include, for example, the following: reducing white space, normalizing to single spaces, changing all text to lower case fonts, etc.). At 606, cropping operations are performed to crop all of the inputs to a fixed length (e.g., of 6,000 characters).

At 104, the encoder is used to encode the input as similarly described above with respect to FIGS. 1 and 2, and the encoded input can be stored in a data store, such as a storage 610 for unlabeled data. At 612, a tokenizer (e.g., using a T5 tokenizer) is used to generate tokens for input to the encoder processing performed at 104.

At 108, the encoded data is processed using the attention network to generate an attention weighted SoEV 118, such as similarly described above with respect to FIGS. 1-3.

The attention weighted SoEV 118 is provided to both discriminator 120 to provide a score vector, and to decoder 130 to provide explanation 132, such as similarly described above with respect to FIGS. 1 and 2. As also shown, ground truth labels 624 can be provided as input to classifier loss 124 during the training phase. Similarly, a desired explanation 626 can be provided as input to the token generation loss 134 during the training phase (e.g., using a commercially/publicly available LLM, such as ChatGPT, to generate desired/target explanations using prompt engineering for generating intuitive human explanations that the model can produce, and which can also be combined with a certain number of human authored explanations used for training and evaluation). As also shown, correction during training (e.g., feedback) can also be performed as shown at 614.

As also shown in FIG. 6, attention network 108 generates a saliency map 618, and the cleaning operations generate offsets as shown at 620. The offsets generated during data cleaning could be necessary to map the global attention values back to the original, uncleaned and unnormalized input (e.g., to display the salient regions of input to a user). In this example implementation, a T5 tokenize is used to provide input to the encoder 104 as also shown.

Based on our experiments, with 63 unique classes for the above-described DLP application, at an enforced false positive rate (FPR) of 0.01%, the classifier achieves a remaining accuracy of 98.90% and, as described above, is also capable of explaining the classifier verdict in natural language. It is noted that this is a significant improvement of a prior implementation that just included the classifier, and did not include a decoder for providing natural language explanations, in which that version with 35 unique classes for the DLP application at an enforced FPR of 0.01%, the classifier only achieved a remaining accuracy of 92.42%.

FIGS. 7A-7C illustrate example DLP verdicts, saliency maps, and natural language explanations in accordance with some embodiments. Specifically, in these examples of documents provided to the above-described DLP application, the red font of the text of the document corresponds to highly attended to content whereas the dark blue font corresponds to highly not attended to content, which illustrates the effectiveness of the saliency of the input text based on the disclosed attention network related techniques to facilitate accurate ML model classification as well as understandable and relevant natural language explanations of these example DLP verdicts.

### Example Process Embodiments for a Neural Architecture for Explainable Classification (XCLS) with Natural Language Justification and Explicit Saliency Detection

FIG. 8 is a flow diagram for a process for applying a neural architecture for explainable classification (XCLS) with natural language justification and explicit saliency detection in accordance with some embodiments. In some embodiments, a process as shown in FIG. 8 is performed by the neural architecture for XCLS with natural language justification and explicit saliency detection and techniques as similarly described above including the embodiments described above with respect to FIGS. 1-7C.

At 802, generating a classifier that is applied to perform the following: (1) force an explicit selection of salient input regions and (2) co-train a discriminator for security classification and a generator for natural language explanation with shared weights is performed, such as similarly described above with respect to FIGS. 1-5.

At 804, applying the discriminator, the generator, and attention losses to jointly learn to up-weight a salient subset of spatial input regions (e.g., to facilitate alignment) is performed, such as similarly described above with respect to FIGS. 1-5.

At 806, generating a discriminator verdict using the classifier based on this bottlenecked information, and sending the bottlenecked information and the discriminator verdict to the generator to output a natural language explanation of the discriminator verdict is performed, such as similarly described above with respect to FIGS. 1-5.

FIG. 9 is another flow diagram for a process for applying a neural architecture for explainable classification (XCLS) with natural language justification and explicit saliency detection in accordance with some embodiments. In some embodiments, a process as shown in FIG. 9 is performed by the neural architecture for XCLS with natural language justification and explicit saliency detection and techniques as similarly described above including the embodiments described above with respect to FIGS. 1-7C.

At 902, a document for Data Loss Prevention (DLP) analysis is received. For example, a text document can be received as input, such as similarly described above with respect to FIG. 6.

At 904, a verdict classifying the document into one of a plurality of classes is generated using an ML model classifier, such as similarly described above with respect to FIG. 6. In an example implementation, a saliency map is also generated to determine the relevant portions of the document (e.g., the most important/salient portions of the document) related to its classification into one of a plurality of classes (e.g., which is fed as input into processing stage 904), such as similarly described above with respect to FIGS. 1-7.

At 906, a natural language explanation of the classifier verdict is generated, such as similarly described above with respect to FIG. 6.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system for a neural architecture for explainable classification (XCLS) with natural language justification, comprising:
a processor configured to:
generate a classifier that is applied to perform the following: (1) force an explicit selection of salient input regions and (2) co-train a discriminator for security classification and a generator for natural language explanation with shared weights;
apply the discriminator, the generator, and attention losses to jointly learn to up-weight a salient subset of spatial input regions to ensure alignment; and
generate a discriminator verdict using the classifier based on this bottlenecked information, and use the generator to output a natural language explanation of the discriminator verdict; and
a memory coupled to the processor and configured to provide the processor with instructions.

2. The system of claim 1, wherein the classifier comprises a neural network.

3. The system of claim 1, wherein the classifier comprises a neural network that co-trains the discriminator for the security classification and the generator for the natural language explanation with the shared weights based on an attention-weighted Sequence of Embedding Vectors (SoEV) from a global attention network.

4. The system of claim 1, wherein applying the discriminator, the generator, and attention losses to jointly learn to up-weight a salient subset of spatial input regions is performed while down-weighting a rest of an input to ensure alignment.

5. The system of claim 1, wherein the generator for natural language explanation comprises a Large-Language Model (LLM) decoder.

6. The system of claim 1, wherein the generator for natural language explanation comprises a Large-Language Model (LLM) decoder, and wherein prompt engineering with the LLM decoder is used to gather target explanation data.

7. The system of claim 1, wherein training input comprises text-based content that is normalized.

8. The system of claim 1, wherein training input comprises text, images, video, audio, and/or other forms of content.

9. The system of claim 1, wherein the neural architecture for XCLS with natural language justification is provided for a data loss prevention (DLP) solution.

10. The system of claim 1, wherein the neural architecture for XCLS with natural language justification is provided for a data loss prevention (DLP) solution, and wherein an output of an encoder of DLP documents is provided to a global attention network.

11. The system of claim 1, wherein the processor is further configured to:
generate a saliency map to facilitate further explainability of a classifier verdict.

12. The system of claim 1, wherein the processor is further configured to:
embed saliency detection into a forward pass of a neural architecture, producing the saliency detection automatically with every classifier verdict, wherein the performance of the discriminator and the generator are enhanced by each other's presence during training.

13. A method for a neural architecture for explainable classification (XCLS) with natural language justification, comprising:
generating a classifier that is applied to perform the following: (1) force an explicit selection of salient input regions and (2) co-train a discriminator for security classification and a generator for natural language explanation with shared weights;
applying the discriminator, the generator, and attention losses to jointly learn to up-weight a salient subset of spatial input regions to ensure alignment; and
generating a discriminator verdict using the classifier based on this bottlenecked information, and using the generator to output a natural language explanation of the discriminator verdict.

14. The method of claim 13, wherein the classifier comprises a neural network.

15. The method of claim 13, wherein the classifier comprises a neural network that co-trains the discriminator for the security classification and the generator for the natural language explanation with the shared weights based on an attention-weighted Sequence of Embedding Vectors (SoEV) from a global attention network.

16. The method of claim 13, wherein applying the discriminator, the generator, and attention losses to jointly learn to up-weight a salient subset of spatial input regions is performed while down-weighting a rest of an input to ensure alignment.

17. The method of claim 13, wherein the generator for natural language explanation comprises a Large-Language Model (LLM) decoder.

18. The method of claim 13, wherein the generator for natural language explanation comprises a Large-Language Model (LLM) decoder, and wherein prompt engineering with the LLM decoder is used to gather target explanation data.

19. A computer program product for a neural architecture for explainable classification (XCLS) with natural language justification embodied in a non-transitory computer readable medium and comprising computer instructions for:
generating a classifier that is applied to perform the following: (1) force an explicit selection of salient input regions and (2) co-train a discriminator for security classification and a generator for natural language explanation with shared weights;
applying the discriminator, the generator, and attention losses to jointly learn to up-weight a salient subset of spatial input regions to ensure alignment; and
generating a discriminator verdict using the classifier based on this bottlenecked information, and using the generator to output a natural language explanation of the discriminator verdict.

20. The computer program product of claim 19, wherein the classifier comprises a neural network.
